(19) United States
(12) Patent Application Publication
(10) Pub. No.: US 2015/0281378 A1
(43) Pub. Date: Oct. 1, 2015

(54) METHOD AND APPARATUS FOR AUTOMATING CREATION OF USER INTERFACE ACROSS MULTI-CLOUDS

(71) Applicant: Avni Networks Inc., Milpitas, CA (US)

(72) Inventors: Rohini Kumar KASTURI, Sunnyvale, CA (US); Anand DESHPANDE, San Jose, CA (US); Vijay Sundar RAJARAM, Fremont, CA (US); Tushar Rajnikant JAGTAP, Sunnyvale, CA (US); Vibhu PRATAP, Santa Clara, CA (US)

(21) Appl. No.: 14/681,066

(22) Filed: Apr. 7, 2015

Related U.S. Application Data
(63) Continuation-in-part of application No. 14/681,057, filed on Apr. 7, 2015.
Application No. 14/681,057 is a continuation-in-part of application No. 14/214,682, filed on Mar. 15, 2014.
Application No. 14/214,682 is a continuation-in-part of application No. 14/214,666, filed on Mar. 15, 2014.
Application No. 14/214,666 is a continuation-in-part of application No. 14/214,612, filed on Mar. 14, 2014.
Application No. 14/214,612 is a continuation-in-part of application No. 14/214,572, filed on Mar. 14, 2014.
Application No. 14/214,572 is a continuation-in-part of application No. 14/214,472, filed on Mar. 14, 2014.
Application No. 14/214,472 is a continuation-in-part of application No. 14/214,326, filed on Mar. 14, 2014.
(60) Provisional application No. 61/977,049, filed on Apr. 8, 2014.

(51) Int. Cl. H04L 29/08

(52) U.S. Cl. CPC H04L 67/16; H04L 67/02

(57) ABSTRACT

A multi-cloud fabric system includes a compiler that receives a data model and automatically generate artifacts for use by a plurality of plugins, the artifacts being distinct for each of the plugins, the artifacts used to create an image of a user interface (UI). A UI tier receives the image of the UI to create a user UI. Therefore, user UI is generated automatically and the multi-cloud fabric system is data-driven to support multiple users.

### CROSS-REFERENCE TO RELATED APPLICATIONS

This application claims priority to U.S. Provisional Patent Application No. 61/977,049, filed on Apr. 8, 2014, by Rohini Kumar Kasturi, et al., and entitled “METHOD AND APPARATUS TO CREATE AND PUBLISH USER INTERFACE (UI) FOR ANY CLOUD MANAGEMENT PLATFORM WITH CENTRALIZED MONITORING, DYNAMIC ORCHESTRATION OF APPLICATIONS WITH NETWORK SERVICES, WITH PERFORMANCE AND SERVICE ASSURANCE CAPABILITIES ACROSS MULTI-CLOUDS”, and is a continuation-in-part of U.S. patent application Ser. No. 14/681,057, filed on Apr. 7, 2015, by Rohini Kumar Kasturi, et al., and entitled “SMART NETWORK AND SERVICE ELEMENTS”, which is a continuation-in-part of U.S. patent application Ser. No. 14/214,682, filed on Mar. 17, 2014, by Kasturi et al. and entitled “METHOD AND APPARATUS FOR CLOUD BURSTING AND CLOUD BALANCING OF INSTANCES ACROSS CLOUDS”, which is a continuation-in-part of U.S. patent application Ser. No. 14/214,666, filed on Mar. 17, 2014, by Kasturi et al., and entitled “METHOD AND APPARATUS FOR AUTOMATIC ENABLEMENT OF NETWORK SERVICES FOR ENTERPRISES”, which is a continuation-in-part of U.S. patent application Ser. No. 14/214,612, filed on Mar. 14, 2014, by Kasturi et al., and entitled “METHOD AND APPARATUS FOR RAPID INSTANCE DEPLOYMENT ON A CLOUD USING A MULTI-CLOUD CONTROLLER”, which is a continuation-in-part of U.S. patent application Ser. No. 14/214,572, filed on Mar. 14, 2014, by Kasturi et al., and entitled “METHOD AND APPARATUS FOR ENSURING APPLICATION AND NETWORK SERVICE PERFORMANCE IN AN AUTOMATED MANNER”, which is a continuation-in-part of U.S. patent application Ser. No. 14/214,472, filed on Mar. 14, 2014, by Kasturi et al., and entitled, “PROCESSES FOR A HIGHLY SCALABLE, DISTRIBUTED, MULTI-CLOUD SERVICE DEPLOYMENT, ORCHESTRATION AND DELIVERY FABRIC”, which is a continuation-in-part of U.S. patent application Ser. No. 14/214,326, filed on Mar. 14, 2014, by Kasturi et al., and entitled, “METHOD AND APPARATUS FOR HIGHLY SCALABLE, MULTI-CLOUD SERVICE DEVELOPMENT, ORCHESTRATION AND DELIVERY”, which are incorporated herein by reference as though set forth in full.

### BACKGROUND

### Field of the Invention

Various embodiments of the invention relate generally to a multi-cloud fabric system and particularly to a distributed application delivery multi-cloud fabric system.

Data centers refer to facilities used to house computer systems and associated components, such as telecommunications (networking equipment) and storage systems. They generally include redundancy, such as redundant data communications connections and power supplies. These computer systems and associated components generally make up the Internet. A metaphor for the Internet is cloud.

A large number of computers connected through a real-time communication network such as the Internet generally form a cloud. Cloud computing refers to distributed computing over a network, and the ability to run a program or application on many connected computers of one or more clouds at the same time.

The cloud has become one of the, or perhaps even the, most desirable platform for storage and networking. A data center with one or more clouds may have server, switch, storage systems, and other networking and storage hardware, but actually served up by virtual hardware, simulated by software running on one or more networking machines and storage systems. Therefore, virtual servers, storage systems, switches and other networking equipment are employed. Such virtual equipment do not physically exist and can therefore be moved around and scaled up or down on the fly without any difference to the end user, somewhat like a cloud becoming larger or smaller without being a physical object. Cloud bursting refers to a cloud, including networking equipment, becoming larger or smaller.

Clouds also focus on maximizing the effectiveness of shared resources, resources referring to machines or hardware such as storage systems and/or networking equipment. Sometimes, these resources are referred to as instances. Cloud resources are usually not only shared by multiple users but are also dynamically reallocated per demand. This can work for allocating resources to users. For example, a cloud computer facility, or a data center, that serves Australian users during Australian business hours with a specific application (e.g., email) may reallocate the same resources to serve North American users during North America's business hours with a different application (e.g., a web server). With cloud computing, multiple users can access a single server to retrieve and update their data without purchasing licenses for different applications.

Cloud computing allows companies to avoid upfront infrastructure costs, and focus on projects that differentiate their businesses, not their infrastructure. It further allows enterprises to get their applications up and running faster, with improved manageability and less maintenance, and that enable information technology (IT) to more rapidly adjust resources to meet fluctuating and unpredictable business demands.

Fabric computing or unified computing involves the creation of a computing fabric system consisting of interconnected nodes that look like a ‘weave’ or a ‘fabric’ when viewed collectively from a distance. Usually this refers to a consolidated high-performance computing system consisting of loosely coupled storage, networking and parallel processing functions linked by high bandwidth interconnects.

The fundamental components of fabrics are “nodes” (processor(s), memory, and/or peripherals) and “links” (functional connection between nodes). Manufacturers of fabrics (or fabric systems) include companies, such as IBM and Brocade. These companies are examples of fabrics made of hardware. Fabrics are also made of software or a combination of hardware and software.

A data center employed with a cloud currently suffers from latency, crashes due to underestimated usage, inefficiently uses of storage and networking systems of the cloud, and perhaps most importantly of all, manually deploying applications. Application deployment services are performed manually, in large part, with elaborate infrastructure, numerous teams of professionals, and reaped with more than tolerable failures due to unexpected bottlenecks. At a minimum, the foregoing translates into high costs and undue delays resulting from lack of automation for launching business applications. It is estimated that application delivery services currently consume approximately thirty percent of the time required for deployment operations. Additionally, scalability of applications across multiple clouds is nearly nonexistent.

An example of lack of automation is noted in the creation and centralization of a User Interface (UI). Currently, the process of generating a user interface in data centers is done manually with a team of people working months on end. This is obviously costly and time-consuming.

### SUMMARY

Briefly, a multi-cloud fabric system includes a compiler that receives a data model and automatically generate artifacts for use by a plurality of plugins, the artifacts being distinct for each of the plugins, the artifacts used to create an image of a user interface (UI). A UI tier receives the image of the UI to create a user UI. Therefore, user UI is generated automatically and the multi-cloud fabric system is data-driven to support multiple users.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a data center 100, in accordance with an embodiment of the invention.

FIG. 2 shows details of relevant portions of the data center 100 and in particular, the fabric system 106 of FIG. 1.

FIG. 3 shows, conceptually, various features of the data center 300, in accordance with an embodiment of the invention.

FIG. 4 shows, in conceptual form, relevant portions of a multi-cloud data center 400, in accordance with another embodiment of the invention.

FIGS. 4a-c show exemplary data centers configured using various embodiments and methods of the invention.

FIG. 5 shows a system 500 for generating UI screenshots, in a networking system, defining tiers and profiles.

FIG. 6 shows a portion of a multi-cloud fabric system 602 including a controller 604.

FIG. 7 shows a build server, in accordance with an embodiment of the invention.

FIG. 8 shows a networking system using various methods and embodiments of the invention.

### DETAILED DESCRIPTION OF EMBODIMENTS

The following description describes a multi-cloud fabric system. The multi-cloud fabric system has a compiler that uses one or more data models to generate artifacts for use by a (master or slave) controller of a cloud thereby automating the process of building a user interface (UI). To this end, a data-driven rather than a manual approach is employed. This can be done among numerous clouds and clouds of different types.

In an embodiment and method of the invention, the artifacts are based on the controller being employed in the cloud.

In an embodiment and method of the invention, the compiler generates different artifacts for different controller. Artifacts are generated for orchestrated infrastructures automatically.

The data model used by the compiler is defined for the UI on an on-demand basis and typically when clouds are being added or removed or features and being added or removed and a host of other reasons.

The data model may be in any desired format, such as without limitation, XML.

Particular embodiments and methods of the invention disclose a virtual multi-cloud fabric system. Still other embodiments and methods disclose automation of application delivery by use of the multi-cloud fabric system.

In other embodiments, a data center includes a plug-in, application layer, multi-cloud fabric, network, and one or more the same or different types of clouds.

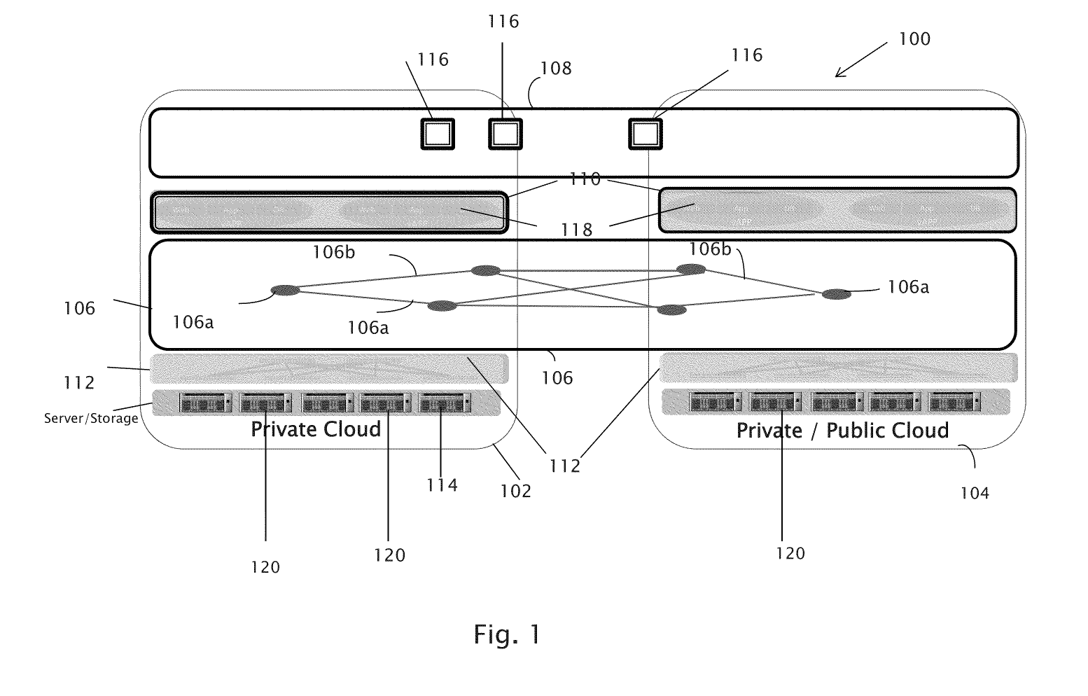

Referring now to FIG. 1, a data center 100 is shown, in accordance with an embodiment of the invention. The data center 100 is shown to include a private cloud 102 and a hybrid cloud 104. A hybrid cloud is a combination public and private cloud. The data center 100 is further shown to include a plug-in unit 108 and a multi-cloud fabric system 106 spanning across the clouds 102 and 104. Each of the clouds 102 and 104 are shown to include a respective application layer 110, a network 112, and resources 114.

The network 112 includes switches, router, and the like and the resources 114 includes networking and storage equipment, i.e. machines, such as without limitation, servers, storage systems, switches, servers, routers, or any combination thereof.

The application layers 110 are each shown to include applications 118, which may be similar or entirely different or a combination thereof.

The plug-in unit 108 is shown to include various plug-ins (orchestration). As an example, in the embodiment of FIG. 1, the plug-in unit 108 is shown to include several distinct plug-ins 116, such as one made by Opensource, another made by Microsoft, Inc., and yet another made by VMware, Inc. The foregoing plug-ins typically each use different formats. The plug-in unit 108 converts all of the various formats of the applications (plug-ins) into one or more native-format applications for use by the multi-cloud fabric system 106. The native-format application(s) is passed through the application layer 110 to the multi-cloud fabric system 106.

The multi-cloud fabric system 106 is shown to include various nodes 106a and links 106b connected together in a weave-like fashion. Nodes 106a are network, storage, or telecommunication or communications devices such as, without limitation, computers, hubs, bridges, routers, mobile units, or switches attached to computers or telecommunications network, or a point in the network topology of the multi-cloud fabric system 106 where lines intersect or terminate. Links 106b are typically data links,

In some embodiments of the invention, the plug-in unit 108 and the multi-cloud fabric system 106 do not span across clouds and the data center 100 includes a single cloud. In embodiments with the plug-in unit 108 and multi-cloud fabric system 106 spanning across clouds, such as that of FIG. 1, resources of the two clouds 102 and 104 are treated as resources of a single unit. For example, an application may be distributed across the resources of both clouds 102 and 104 homogeneously thereby making the clouds seamless. This allows use of analytics, searches, monitoring, reporting, displaying and otherwise data crunching thereby optimizing services and use of resources of clouds 102 and 104 collectively.

While two clouds are shown in the embodiment of FIG. 1, it is understood that any number of clouds, including one cloud, may be employed. Furthermore, any combination of private, public and hybrid clouds may be employed. Alternatively, one or more of the same type of cloud may be employed.

In an embodiment of the invention, the multi-cloud fabric system 106 is a Layer (L) 4-7 fabric system. Those skilled in the art appreciate data centers with various layers of networking. As earlier noted, multi-cloud fabric system 106 is made of nodes 106a and connections (or “links”) 106b. In an embodiment of the invention, the nodes 106a are devices, such as but not limited to L4-L7 devices. In some embodiments, the multi-cloud fabric system 106 is implemented in software and in other embodiments, it is made with hardware and in still others, it is made with hardware and software.

Some switches can use up to OSI layer 7 packet information; these may be called layer (L) 4-7 switches, content-switches, content services switches, web-switches or application-switches.

Content switches are typically used for load balancing among groups of servers. Load balancing can be performed on HTTP, HTTPS, VPN, or any TCP/IP traffic using a specific port. Load balancing often involves destination network address translation so that the client of the load balanced service is not fully aware of which server is handling its requests. Content switches can often be used to perform standard operations, such as SSL encryption/decryption to reduce the load on the servers receiving the traffic, or to centralize the management of digital certificates. Layer 7 switching is the base technology of a content delivery network.

The multi-cloud fabric system 106 sends one or more applications to the resources 114 through the networks 112.

In a service level agreement (SLA) engine, as will be discussed relative to a subsequent figure, data is acted upon in real-time. Further, the data center 100 dynamically and automatically delivers applications, virtually or in physical reality, in a single or multi-cloud of either the same or different types of clouds.

The data center 100, in accordance with some embodiments and methods of the invention, functions as a service (Software as a Service (SAAS) model, a software package through existing cloud management platforms, or a physical appliance for high scale requirements. Further, licensing can be throughput or flow-based and can be enabled with network services only, network services with SLA and elasticity engine (as will be further evident below), network service enablement engine, and/or multi-cloud engine.

As will be further discussed below, the data center 100 may be driven by representational state transfer (REST) application programming interface (API).

The data center 100, with the use of the multi-cloud fabric system 106, eliminates the need for an expensive infrastructure, manual and static configuration of resources, limitation of a single cloud, and delays in configuring the resources, among other advantages. Rather than a team of professionals configuring the resources for delivery of applications over months of time, the data center 100 automatically and dynamically does the same, in real-time. Additionally, more features and capabilities are realized with the data center 100 over that of prior art. For example, due to multi-cloud and virtual delivery capabilities, cloud bursting to existing clouds is possible and utilized only when required to save resources and therefore expenses.

Moreover, the data center 100 effectively has a feedback loop in the sense that results from monitoring traffic, performance, usage, time, resource limitations and the like, i.e. the configuration of the resources can be dynamically altered based on the monitored information. A log of information pertaining to configuration, resources, the environment, and the like allow the data center 100 to provide a user with pertinent information to enable the user to adjust and substantially optimize its usage of resources and clouds. Similarly, the data center 100 itself can optimize resources based on the foregoing information.

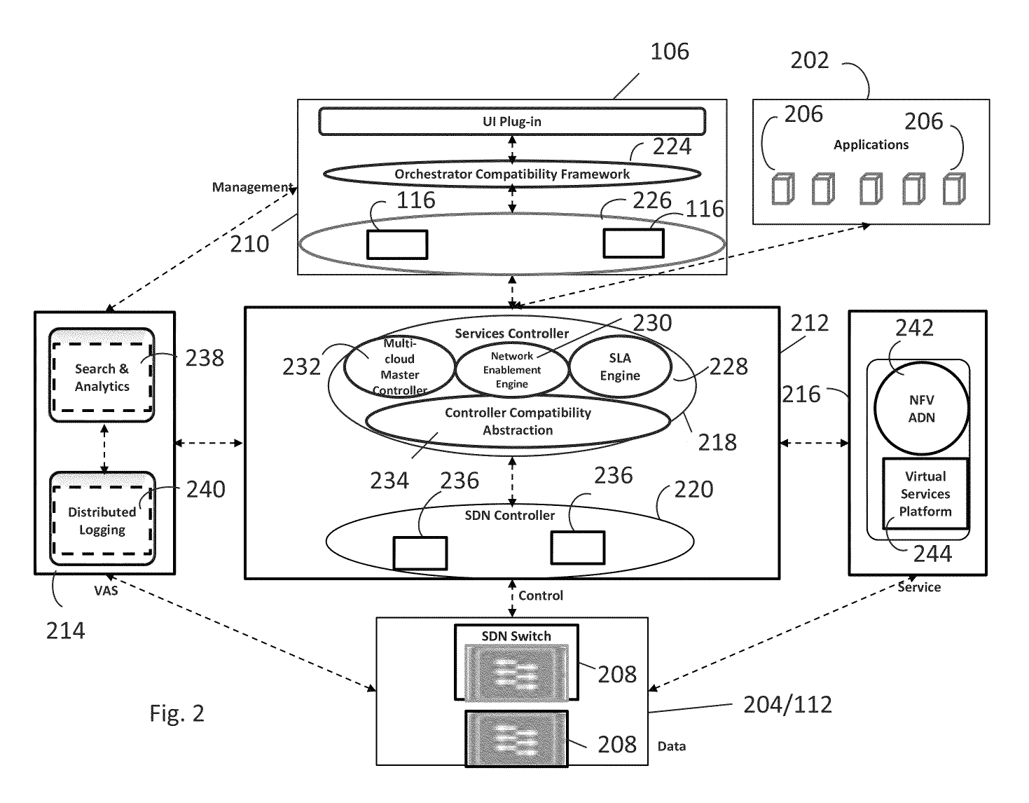

FIG. 2 shows further details of relevant portions of the data center 100 and in particular, the fabric system 106 of FIG. 1. The fabric system 106 is shown to be in communication with a applications unit 202 and a network 204, which is shown to include a number of Software Defined Networking (SDN)-enabled controllers and switches 208. The network 204 is analogous to the network 112 of FIG. 1.

The applications unit 202 is shown to include a number of applications 206, for instance, for an enterprise. These applications are analyzed, monitored, searched, and otherwise crunched just like the applications from the plug-ins of the fabric system 106 for ultimate delivery to resources through the network 204.

The data center 100 is shown to include five units (or planes), the management unit 210, the value-added services (VAS) unit 214, the controller unit 212, the service unit 216 and the data unit (or network) 204. Accordingly and advantageously, control, data, VAS, network services and management are provided separately. Each of the planes is an agent and the data from each of the agents is crunched by the controller unit 212 and the VAS unit 214.

The fabric system 106 is shown to include the management unit 210, the VAS unit 214, the controller unit 212 and the service unit 216. The management unit 210 is shown to include a user interface (UI) plug-in 222, an orchestrator compatibility framework 224, and applications 226. The management unit 210 is analogous to the plug-in 108. The UI plug-in 222 and the applications 226 receive applications of various formats and the framework 224 translates the various formatted application into native-format applications. Examples of plug-ins 116, located in the applications 226, are VMware ICenter, by VMware, Inc. and System Center by Microsoft, Inc. While two plug-ins are shown in FIG. 2, it is understood that any number may be employed.

The controller unit 212 serves as the master or brain of the data center 100 in that it controls the flow of data throughout the data center and timing of various events, to name a couple of many other functions it performs as the mastermind of the data center. It is shown to include a services controller 218 and a SDN controller 220. The services controller 218 is shown to include a multi-cloud master controller 232, an application delivery services stitching engine or network enablement engine 230, a SLA engine 228, and a controller compatibility abstraction 234.

Typically, one of the clouds of a multi-cloud network is the master of the clouds and includes a multi-cloud master controller that talks to local cloud controllers (or managers) to help configure the topology among other functions. The master cloud includes the SLA engine 228 whereas other clouds need not to but all clouds include a SLA agent and a SLA aggregator with the former typically being a part of the virtual services platform 244 and the latter being a part of the search and analytics 238.

The controller compatibility abstraction 234 provides abstraction to enable handling of different types of controllers (SDN controllers) in a uniform manner to offload traffic in the switches and routers of the network 204. This increases response time and performance as well as allowing more efficient use of the network.

The network enablement engine 230 performs stitching where an application or network services (such as configuring load balance) is automatically enabled. This eliminates the need for the user to work on meeting, for instance, a load balance policy. Moreover, it allows scaling out automatically when violating a policy.

The flex cloud engine 232 handles multi-cloud configurations such as determining, for instance, which cloud is less costly, or whether an application must go onto more than one cloud based on a particular policy, or the number and type of cloud that is best suited for a particular scenario.

The SLA engine 228 monitors various parameters in real-time and decides if policies are met. Exemplary parameters include different types of SLAs and application parameters. Examples of different types of SLAs include network SLAs and application SLAs. The SLA engine 228, besides monitoring allows for acting on the data, such as service plane (L4-L7), application, network data and the like, in real-time.

The practice of service assurance enables Data Centers (DCs) and (or) Cloud Service Providers (CSPs) to identify faults in the network and resolve these issues in a timely manner so as to minimize service downtime. The practice also includes policies and processes to proactively pinpoint, diagnose and resolve service quality degradations or device malfunctions before subscribers (users) are impacted.

Service assurance encompasses the following:
Fault and event management
   Performance management
   Probe monitoring
   Quality of service (QoS) management
   Network and service testing
   Network traffic management
   Customer experience management
   Real-time SLA monitoring and assurance
   Service and Application availability
   Trouble ticket management

The structures shown included in the controller unit 212 are implemented using one or more processors executing software (or code) and in this sense, the controller unit 212 may be a processor. Alternatively, any other structures in FIG. 2 may be implemented as one or more processors executing software. In other embodiments, the controller unit 212 and perhaps some or all of the remaining structures of FIG. 2 may be implemented in hardware or a combination of hardware and software.

VAS unit 214 uses its search and analytics unit 238 to search analytics based on distributed large data engine and crunches data and displays analytics. The search and analytics unit 238 can filter all of the logs the distributed logging unit 240 of the VAS unit 214 logs, based on the customer's (user's) desires. Examples of analytics include events and logs. The VAS unit 214 also determines configurations such as who needs SLA, who is violating SLA, and the like.

The SDN controller 220, which includes software defined network programmability, such as those made by Floodlight, Open Daylight, PDX, and other manufacturers, receives all the data from the network 204 and allows for programmability of a network switch/router.

The service plane 216 is shown to include an API based, Network Function Virtualization (NFV), Application Delivery Network (ADN) 242 and on a Distributed virtual services platform 244. The service plane 216 activates the right components based on rules. It includes ADC, web-application firewall, DPI, VPN, DNS and other L4-L7 services and configures based on policy (it is completely distributed). It can also include any application or L4-L7 network services.

The distributed virtual services platform contains an Application Delivery Controller (ADC), Web Application Firewall (Firewall), L2-L3 Zonal Firewall (ZFW), Virtual Private Network (VPN), Deep Packet Inspection (DPI), and various other services that can be enabled as a single-pass architecture. The service plane contains a Configuration agent, Stats/Analytics reporting agent, Zero-copy driver to send and receive packets in a fast manner, Memory mapping engine that maps memory via TLB to any virtualized platform/hypervisor, SSL offload engine, etc.

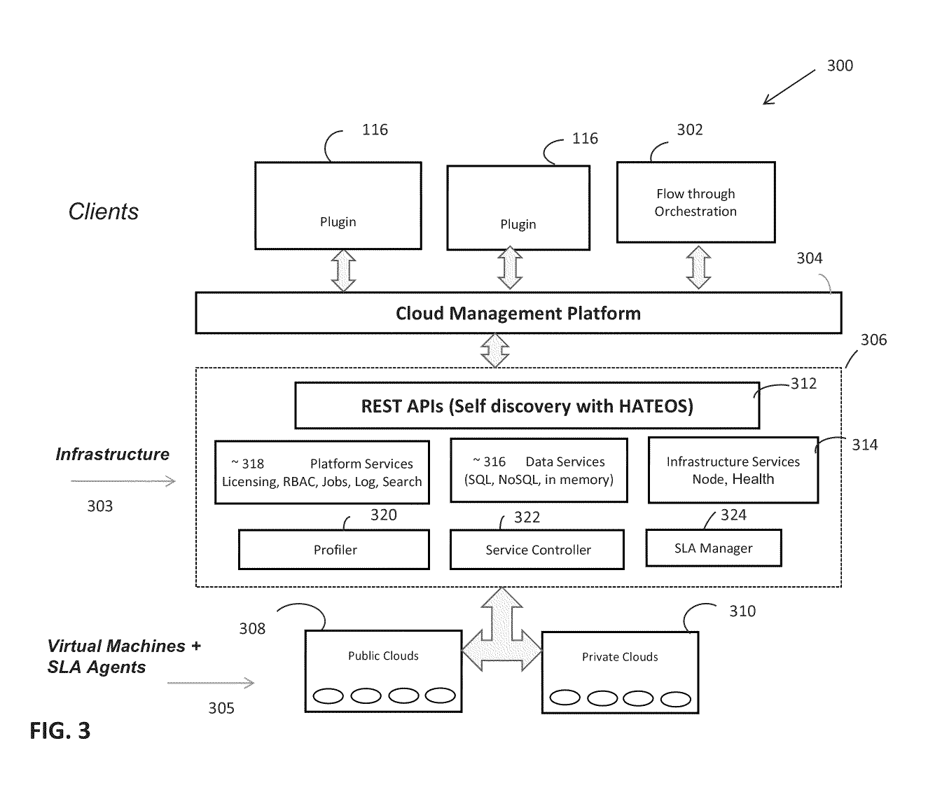

FIG. 3 shows conceptually various features of the data center 300, in accordance with an embodiment of the invention. The data center 300 is analogous to the data center 100 except some of the features/structures of the data center 300 are in addition to those shown in the data center 100. The data center 300 is shown to include plug-ins 116, flow-through orchestration 302, cloud management platform 304, controller 306, and public and private clouds 308 and 310, respectively.

The controller 306 is analogous to the controller unit 212 of FIG. 2. In FIG. 3, the controller 306 is shown to include a REST APIs-based invocations for self-discovery, platform services 318, data services 316, infrastructure services 314, profiler 320, service controller 322, and SLA manager 324.

The flow-through orchestration 302 is analogous to the framework 224 of FIG. 2. Plug-ins 116 and orchestration 302 provide applications to the cloud management platform 304, which converts the formats of the applications to native format. The native-formatted applications are processed by the controller 306, which is analogous to the controller unit 212 of FIG. 2. The RESI APIs 312 drive the controller 306. The platform services 318 is for services such as licensing, Role Based Access and Control (RBAC), jobs, log, and search. The data services 316 is to store data of various components, services, applications, databases such as Search and Query Language (SQL), NoSQL, data in memory. The infrastructure services 314 is for services such as node and health.

The profiler 320 is a test engine. Service controller 322 is analogous to the controller 220 and SLA manager 324 is analogous to the SLA engine 228 of FIG. 2. During testing by the profiler 320, simulated traffic is run through the data center 300 to test for proper operability as well as adjustment of parameters such as response time, resource and cloud requirements, and processing usage.

In the exemplary embodiment of FIG. 3, the controller 306 interacts with public clouds 308 and private clouds 310. Each of the clouds 308 and 310 include multiple clouds and communicate not only with the controller 306 but also with each other. Benefits of the clouds communicating with one another is optimization of traffic path, dynamic traffic steering, and/or reduction of costs, among perhaps others.

The plug-ins 116 and the flow-through orchestration 302 are the clients 310 of the data center 300, the controller 306 is the infrastructure of the data center 300, and the clouds 308 and 310 are the virtual machines and SLA agents 305 of the data center 300.

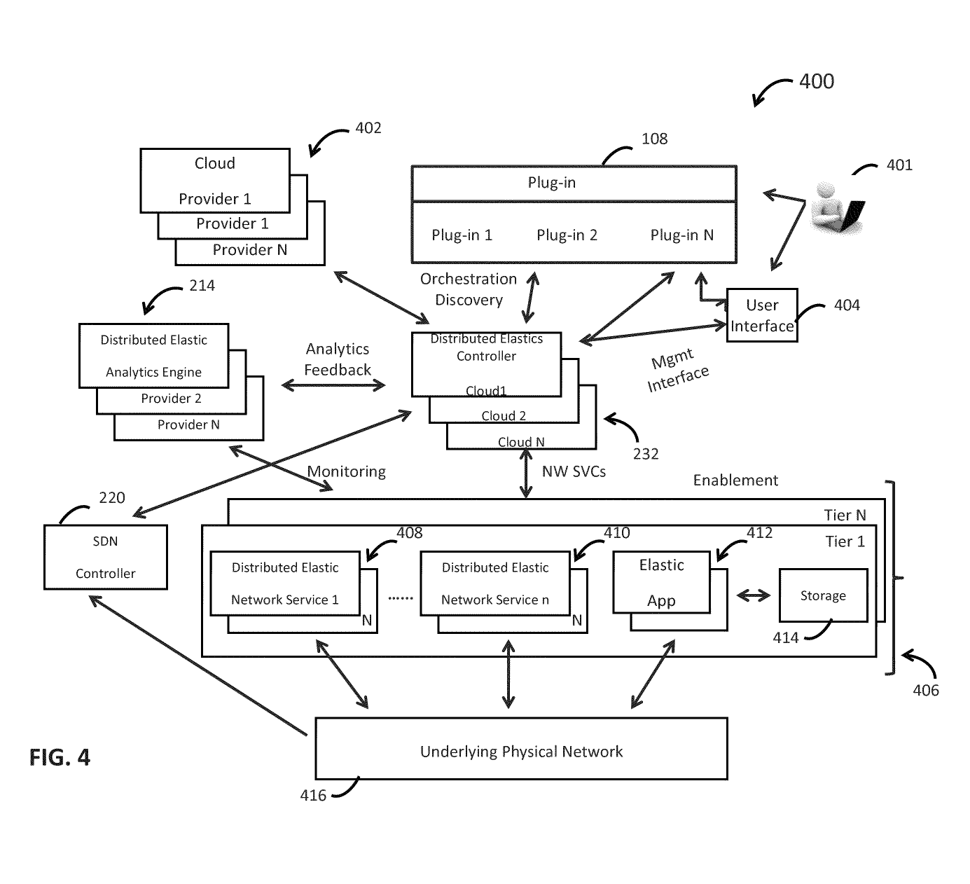

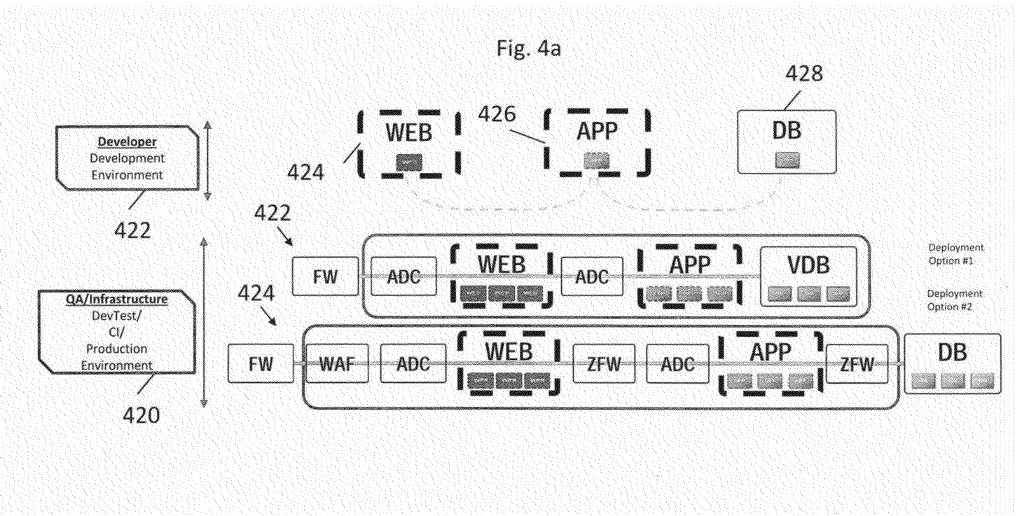

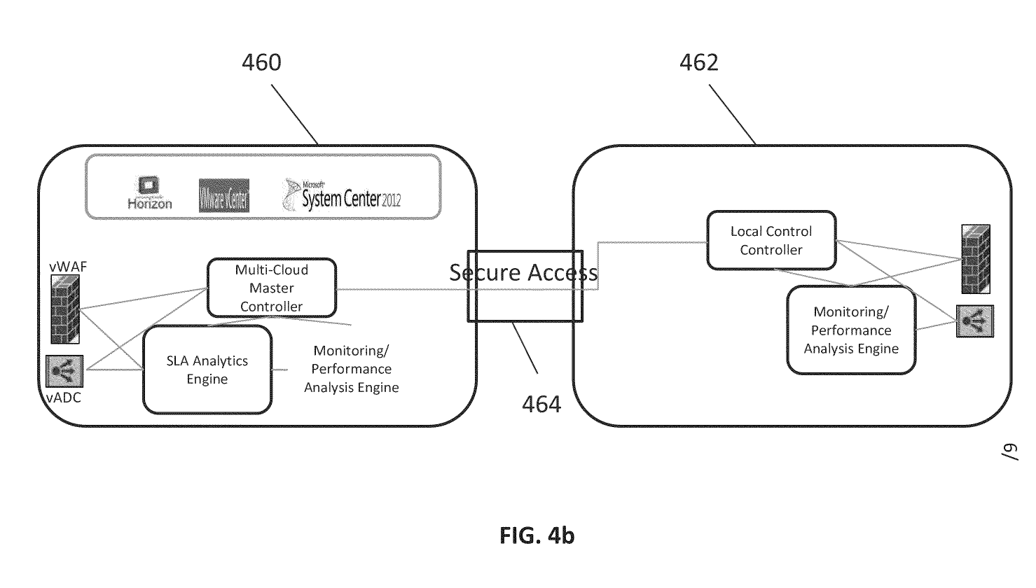

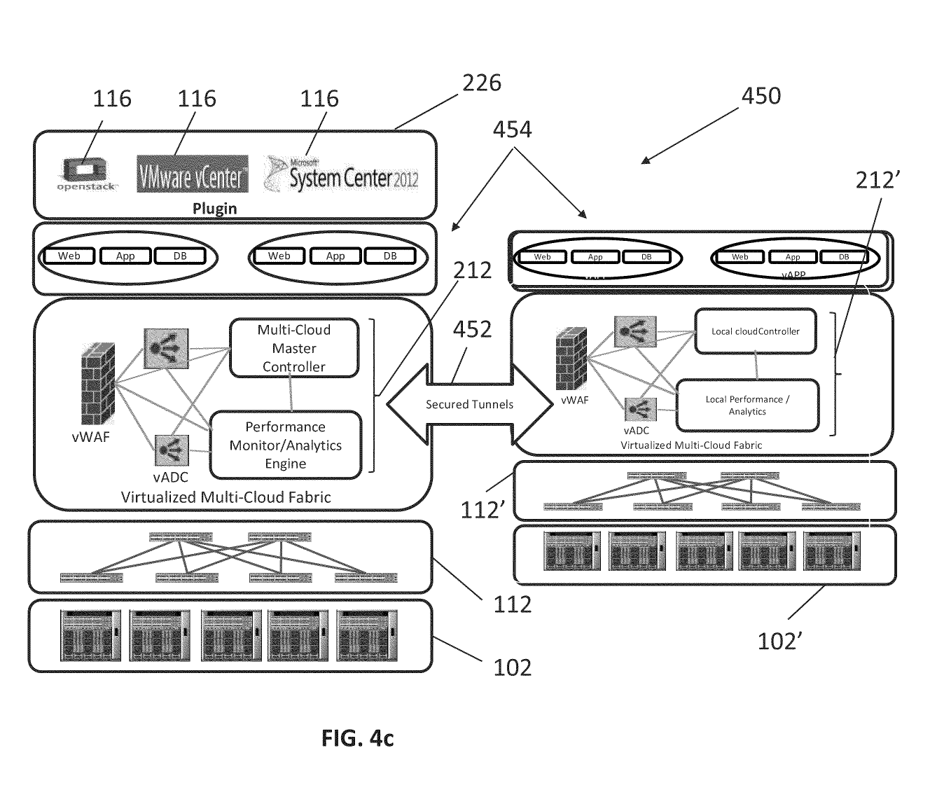

FIG. 4 shows, in conceptual form, relevant portion of a multi-cloud data center 400, in accordance with another embodiment of the invention. A client (or user) 401 is shown to use the data center 400, which is shown to include plug-in units 108, cloud providers 1-N 402, distributed elastic analytics engine (or “VAS unit”) 214, distributed elastic controller (of clouds 1-N) (also known herein as “flex cloud engine” or “multi-cloud master controller”) 232, tiers 1-N, underlying physical NW 416, such as Servers, Storage, Network elements, etc. and SDN controller 220.

Each of the tiers 1-N is shown to include distributed elastic 1-N, 408-410, respectively, elastic applications 412, and storage 414. The distributed elastic 1-N 408-410 and elastic applications 412 communicate bidirectional with the underlying physical NW 416 and the latter unilaterally provides information to the SDN controller 220. A part of each of the tiers 1-N are included in the service plane 216 of FIG. 2.

The cloud providers 402 are providers of the clouds shown and/or discussed herein. The distributed elastic controllers 1-N each service a cloud from the cloud providers 402, as discussed previously except that in FIG. 4, there are N number of clouds, “N” being an integer value.

As previously discussed, the distributed elastic analytics engine 214 includes multiple VAS units, one for each of the clouds, and the analytics are provided to the controller 232 for various reasons, one of which is the feedback feature discussed earlier. The controllers 232 also provide information to the engine 214, as discussed above.

The distributed elastic services 1-N are analogous to the services 318, 316, and 314 of FIG. 3 except that in FIG. 4, the services are shown to be distributed, as are the controllers 232 and the distributed elastic analytics engine 214. Such distribution allows flexibility in the use of resource allocation therefore minimizing costs to the user among other advantages.

The underlying physical NW 416 is analogous to the resources 114 of FIG. 1 and that of other figures herein. The underlying network and resources include servers for running any applications, storage, network elements such as routers, switches, etc. The storage 414 is also a part of the resources.

The tiers 406 are deployed across multiple clouds and are enablement. Enablement refers to evaluation of applications for L4 through L7. An example of enablement is stitching.

In summary, the data center of an embodiment of the invention, is multi-cloud and capable of application deployment, application orchestration, and application delivery.

In operation, the user (or “client”) 401 interacts with the UI 404 and through the UI 404, with the plug-in unit 108. Alternatively, the user 401 interacts directly with the plug-in unit 108. The plug-in unit 108 receives applications from the user with perhaps certain specifications. Orchestration and discover take place between the plug-in unit 108, the controllers 232 and between the providers 402 and the controllers 232. A management interface (also known herein as “management unit” 210) manages the interactions between the controllers 232 and the plug-in unit 108.

The distributed elastic analytics engine 214 and the tiers 406 perform monitoring of various applications, application delivery services and network elements and the controllers 232 effectuate service change.

In accordance with various embodiments and methods of the invention, some of which are shown and discussed herein, an Multi-cloud fabric is disclosed. The Multi-cloud fabric includes an application management unit responsive to one or more applications from an application layer. The Multi-cloud fabric further includes a controller in communication with resources of a cloud, the controller is responsive to the received application and includes a processor operable to analyze the received application relative to the resources to cause delivery of the one or more applications to the resources dynamically and automatically.

The multi-cloud fabric, in some embodiments of the invention, is virtual. In some embodiments of the invention, the multi-cloud fabric is operable to deploy the one or more native-format applications automatically and/or dynamically. In still other embodiments of the invention, the controller is in communication with resources of more than one cloud.

The processor of the multi-cloud fabric is operable to analyze applications relative to resources of more than one cloud.

In an embodiment of the invention, the Value Added Services (VAS) unit is in communication with the controller and the application management unit and the VAS unit is operable to provide analytics to the controller. The VAS unit is operable to perform a search of data provided by the controller and filters the searched data based on the user's specifications (or desire).

In an embodiment of the invention, the multi-cloud fabric system 106 includes a service unit that is in communication with the controller and operative to configure data of a network based on rules from the user or otherwise.

In some embodiments, the controller includes a cloud engine that assesses multiple clouds relative to an application and resources. In an embodiment of the invention, the controller includes a network enablement engine.

In some embodiments of the invention, the application deployment fabric includes a plug-in unit responsive to applications with different format applications and operable to convert the different format applications to a native-format application. The application deployment fabric can report configuration and analytics related to the resources to the user. The application deployment fabric can have multiple clouds including one or more private clouds, one or more public clouds, or one or more hybrid clouds. A hybrid cloud is private and public.

The application deployment fabric configures the resources and monitors traffic of the resources, in real-time, and based at least on the monitored traffic, re-configure the resources, in real-time.

In an embodiment of the invention, the Multi-cloud fabric can stitch end-to-end, i.e. an application to the cloud, automatically.

In an embodiment of the invention, the SLA engine of the Multi-cloud fabric sets the parameters of different types of SLA in real-time.

In some embodiments, the Multi-cloud fabric automatically scales in or scales out the resources. For example, upon an underestimation of resources or unforeseen circumstances requiring addition resources, such as during a super bowl game with subscribers exceeding an estimated and planned for number, the resources are scaled out and perhaps use existing resources, such as those offered by Amazon, Inc. Similarly, resources can be scaled down.

The following are some, but not all, various alternative embodiments. The multi-cloud fabric system is operable to stitch across the cloud and at least one more cloud and to stitch network services, in real-time.

The multi-cloud fabric is operable to burst across clouds other than the cloud and access existing resources.

The controller of the multi-cloud fabric receives test traffic and configures resources based on the test traffic.

Upon violation of a policy, the multi-cloud fabric automatically scales the resources.

The SLA engine of the controller monitors parameters of different types of SLA in real-time.

The SLA includes application SLA and networking SLA, among other types of SLA contemplated by those skilled in the art.

The multi-cloud fabric may be distributed and it may be capable of receiving more than one application with different formats and to generate native-format applications from the more than one application.

The resources may include storage systems, servers, routers, switches, or any combination thereof.

The analytics of the multi-cloud fabric include but not limited to traffic, response time, connections/sec, throughput, network characteristics, disk I/O or any combination thereof.

In accordance with various alternative methods, of delivering an application by the multi-cloud fabric, the multi-cloud fabric receives at least one application, determines resources of one or more clouds, and automatically and dynamically delivers the at least one application to the one or more clouds based on the determined resources. Analytics related to the resources are displayed on a dashboard or otherwise and the analytics help cause the Multi-cloud fabric to substantially optimally deliver the at least one application.

FIGS. 4a-c show exemplary data centers configured using embodiments and methods of the invention. FIG. 4a shows the example of a work flow of a 3-tier application development and deployment. At 422 is shown a developer's development environment including a web tier 424, an application tier 426 and a database 428, each used by a user for different purposes typically and perhaps requiring its own security measure. For example, a company like Yahoo, Inc. may use the web tier 424 for its web and the application tier 426 for its applications and the database 428 for its sensitive data. Accordingly, the database 428 may be a part of a private rather than a public cloud. The tiers 424 and 426 and database 420 are all linked together.

At 420, development testing and production environment is shown. At 422, an optional deployment is shown with a firewall (FW), ADC, a web tier (such as the tier 404), another ADC, an application tier (such as the tier 406), and a virtual database (same as the database 428). ADC is essentially a load balancer. This deployment may not be optimal and actually far from it because it is an initial pass and without the use of some of the optimizations done by various methods and embodiments of the invention. The instances of this deployment are stitched together (or orchestrated).

At 424, another optional deployment is shown with perhaps greater optimization. A FW is followed by a web-application FW (WFW), which is followed by an ADC and so on. Accordingly, the instances shown at 424 are stitched together.

FIG. 4b shows an exemplary multi-cloud having a public, private, or hybrid cloud 460 and another public or private or hybrid cloud 464 communication through a secure access 464. The cloud 460 is shown to include the master controller whereas the cloud 462 is the slave or local cloud controller. Accordingly, the SLA engine resides in the cloud 460.

FIG. 4c shows a virtualized multi-cloud fabric spanning across multiple clouds with a single point of control and management.

In accordance with embodiments and methods of the invention, load balancing is done across multiple clouds.

Although the description has been described with respect to particular embodiments thereof, these particular embodiments are merely illustrative, and not restrictive.

Disclosed herein are methods and apparatus for creating and publishing user interface (UI) for any cloud management platform with centralized monitoring, dynamic orchestration of applications with network services, with performance and service assurance capabilities across multi-clouds.

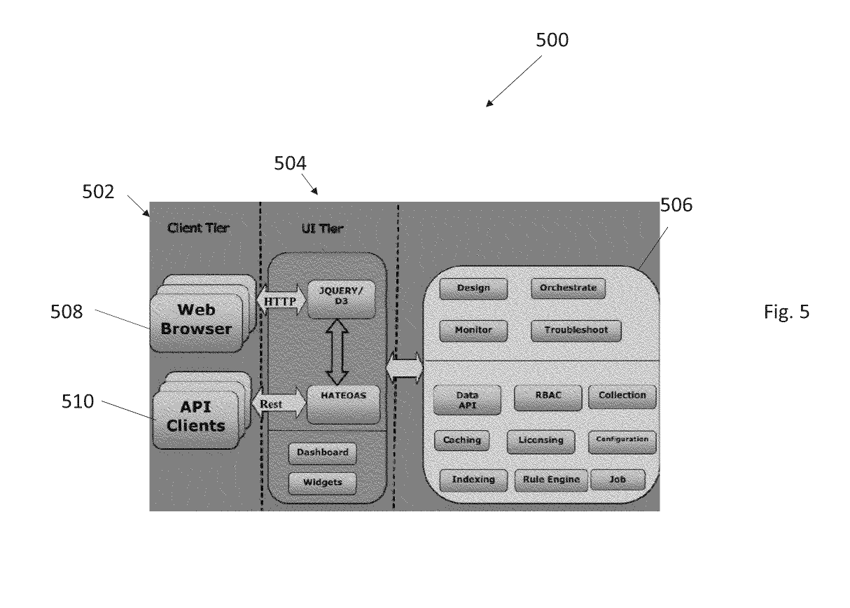

FIG. 5 shows a system 500 for generating UI screenshots, in a networking system, defining tiers and profiles. A hierarchal dashboard is shown starting from projects to applications to tiers and to virtual machines (VMs).

For example, client tier 502, UI tier 504 and networking functions 106 are shown where the client tier 502 includes a web browser 508 that is in communication with a jquery or D3 in the UI tier 504 through HTTP and an API clients 510 of the client tier 102 is shown in communication with a hateoas of the UI tier 104 through REST. The UI tier 104 is also shown to include a dashboard and widgets (desired graphics/data).

The network functions 506 is shown in communication with the UI tier 504 and includes functions such as orchestration, monitoring, troubleshooting, data API, and so forth, which are merely examples of many others.

In operation, projects start at client tier 502, such as the web server 508, resulting in applications in the UI tier 504 and multiple tiers.

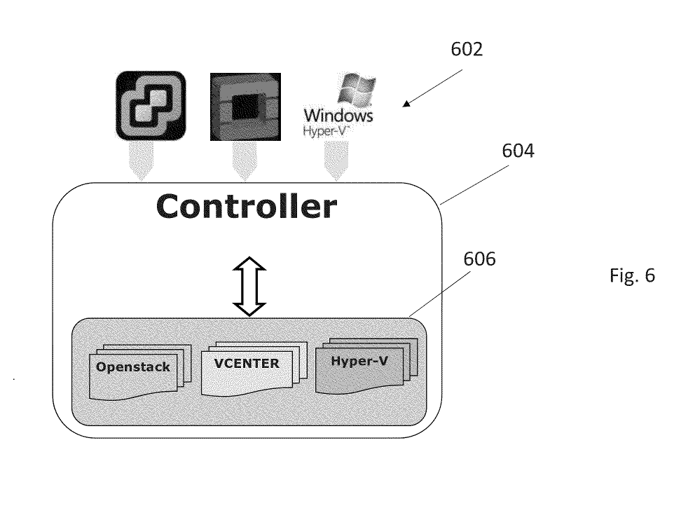

FIG. 6 shows a portion of a multi-cloud fabric system 602/106 including a controller 604. The controller 604 is shown to receive information from various types of plug-in 603. It provides the method to expose that consists of all of the definition files which are needed for publishing the user for respective cloud management platform (CMP).

The plugin, such as one of the plugins 603, is installed on the CMP during load up time, and fetches the definition files from the controller 604 describing the complete workflow compliant with the respective CMP thereby eliminating the need for any update in the CMP for any changes in the workflow.

further details of the controller 604 of FIG. 6, in accordance with an embodiment of the invention. The controller 604 may be thought of as a multi-cloud master controller as it can manage multiple clouds.

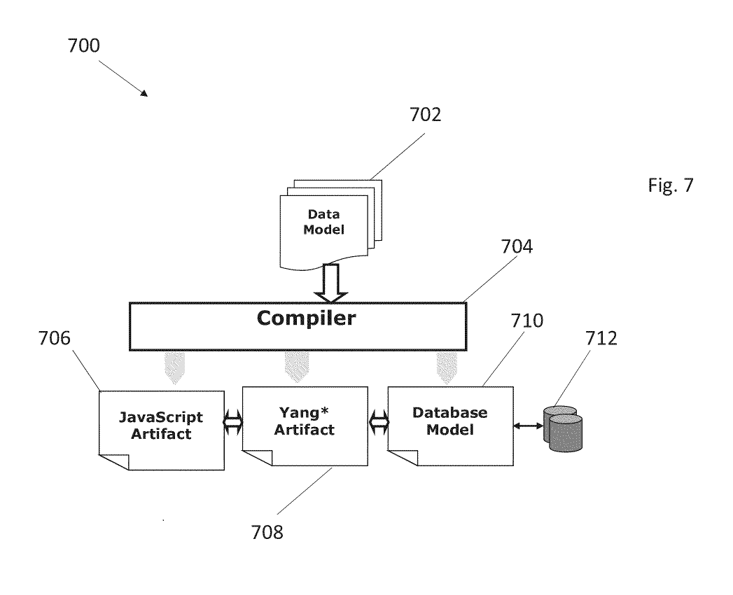

FIG. 7 shows a build server 700 used to generate an image of a UI. The server 700 is shown to include data model(s) 702, a compiler 704, and artifacts 706 and 708, in addition to a database model 710 and database 712.

The data model 702 is shown to be in communication with the complier 704. The compiler 704 is shown to be in communication with various components, such as the database model 710, which is transmitted to and from the database 712. Further shown to be in communication with the compiler 704 are the Java script artifact 706 and the Yang artifact 708. It should be noted that these are merely two examples of artifacts. The artifact 706 is also in communication with the Yang artifact 708, which is in turn in communication with the data base model 710.

The compiler 704 receives an input model, i.e. data model 702, and automatically creates both the client side (such as client tier 502) and server side artifacts (such as artifacts 706 and 708) in addition to the data base model 710, needed for creation and publishing of the User Interface (UI). The data base model 710 is saved and retrieved from the database 712. The database model 710 is used by the UI to retrieved and save inputs from users.

A unique model of deploying multi-tiered VM's working in conjunction to offer the characteristics desired from an application are realized by the methods and apparatus of the invention. The unique characteristics being: Automatic stitching of network services required for tier functioning; and service-level agreement (SLA)-based auto-scaling model in each of the tiers.

Accordingly, the compiler 704 of the multi-cloud fabric system 106 of the data center 100 uses one or more data model(s) 702 to generate artifacts for use by a (master or slave) controller of a cloud, such as the clouds 1002-1006, thereby automating the process of building an UI to be input to the UI tier 504. To this end, artifacts are generated for orchestrated infrastructures automatically and a data-driven, rather than a manual approach, is employed, which can also be done among numerous clouds and clouds of different types.

The output of the compiler 704 is the combination of artifacts 706 and 708, and the database model 710 which in turn are used for creating the UI. The UI is then uploaded to (or used by) the servers 1012, 1014 and/or 1016 is an image of the UI and provided to the UI tier 504 of FIG. 5.

The UI of UI tier 504 may display a dashboard showing various information to a user. UI tier 504, as shown in FIG. 5, also receives information from the network functions 506 that can be used by the UI tier 504 to display on the dashboard. Such information includes but is not limited to features relating to design, orchestration, monitoring, troubleshooting, data API, caching, rule engine, licensing, . . .

In an embodiment and method of the invention, the compiler 704 generates artifacts based on the (master or slave) controller of the servers 1012, 1014, and/or 1016.

In an embodiment and method of the invention, the compiler 704 generates different artifacts for different controllers, for example, controllers of different clouds and cloud types.

The data model 702 used by the compiler 704 is defined for the UI to be created, on an on-demand basis and typically when clouds are being added or removed or features and being added or removed and a host of other reasons. The data model may be in any desired format, such as without limitation, XML.

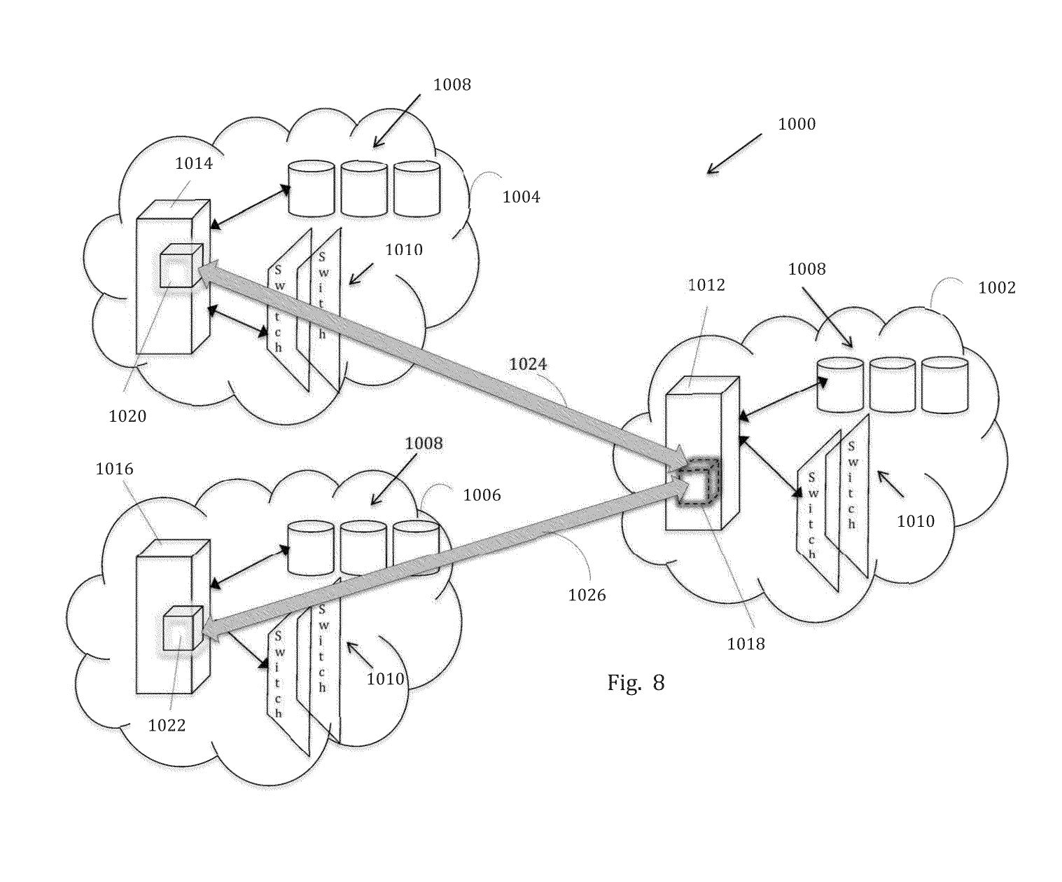

FIG. 8 shows a networking system 1000 using various methods and embodiments of the invention. The system 1000 is analogous to the data center 100 of FIG. 1, but shown to include three clouds, 1002-1006, in accordance with an embodiment of the invention. It is understood that while three clouds are shown in the embodiment of FIG. 8, any number of clouds may be employed without departing from the scope and spirit of the invention.

Each server of each cloud, in FIG. 8, is shown to be communicatively coupled to the databases and switches of the same cloud. For example, the server 1012 is shown to be communicatively coupled to the databases 1008 and switches 1010 of the cloud 1002 and so on.

Each of the clouds 1002-1006 is shown to include databases 1008 and switches 1010, both of which are communicatively coupled to at least one server, typically the server that is in the cloud in which the switches and databases reside. For instance, the databases 1008 and switches 1010 of the cloud 1002 are shown coupled to the server 1012, the databases 1008 and switches 1010 of cloud 1004 are shown coupled to the server 1014, and the databases 1008 and switches 1010 of cloud 1006 are shown coupled to the server 1016. The server 1012 is shown to include a multi-cloud master controller 1018, which is analogous to the multi-cloud master controller 232 of FIG. 2. The server 1014 is shown to include a multi-cloud fabric slave controller 1020 and the server 1016 is shown to include a multi-cloud fabric controller 1022. The controllers 1020 and 1022 are each analogous to each of the slave controllers in 930 and 932 of FIG. 5.

Clouds may be public, private or a combination of public and private. In the example of FIG. 8, cloud 1002 is a private cloud whereas the clouds 1004 and 1006 are public clouds. It is understood that any number of public and private clouds may be employed. Additionally, any one of the clouds 1002-1006 may be a master cloud.

In the embodiment of FIG. 8, the cloud 1002 includes the master controller but alternatively, a public cloud or a hybrid cloud, one that is both public and private, may include a master controller. For example, either of the clouds 1004 and 1006, instead of the cloud 1002, may include the master controller.

In FIG. 8, the controllers 1020 and 1022 are shown to be in communication with the controller 1018. More specifically, the controller 1018 and the controller 1020 communicate with each other through the link 1024 and the controllers 1018 and 1022 communicate with each other through the link 1026. Thus, communication between clouds 1004 and 1006 is conveniently avoided and the controller 1018 masterminds and causes centralization of and coordinates between the clouds 1004 and 1006. As noted earlier, some of these functions, without any limitation, include optimizing resources or flow control.

In some embodiments, the links 1024 and 1026 are each virtual personal network (VPN) tunnels or REST API communication over HTTPS, while others not listed herein are contemplated.

As earlier noted, the databases 1008 each maintain information such as the characteristics of a flow. The switches 1010 of each cloud cause routing of a communication route between the different clouds and the servers of each cloud provide or help provide network services upon a request across a computer network, such as upon a request from another cloud.

The controllers of each server of each of the clouds makes the system 1000 a smart network. The controller 1018 acts as the master controller with the controllers 1020 and 1022 each acting primarily under the guidance of the controller 1018. It is noteworthy that any of the clouds 1002-1006 may be selected as a master cloud, i.e. have a master controller. In fact, in some embodiments, the designation of master and slave controllers may be programmable and/or dynamic. But one of the clouds needs to be designated as a master cloud. Many of the structures discussed hereinabove, reside in the clouds of FIG. 8. Exemplary structures are VAS, SDN controller, SLA engine, and the like.

In an exemplary embodiment, each of the links 1024 and 1026 use the same protocol for effectuating communication between the clouds, however, it is possible for these links to each use a different protocol. As noted above, the controller 1018 centralizes information thereby allowing multiple protocols to be supported in addition to improving the performance of clouds that have slave rather than a master controller.

While not shown in FIG. 8, it is understood that each of the clouds 1002-1006 includes storage space, such as without limitation, solid state disks (SSD), which are typically employed in masses to handle the large amount of data within each of the clouds.

The build server 700 sends the output of the complier 704 to the UI tier 504 of FIG. 5. Practically, among the mechanisms this may be done with, one is using an installation script, generated by the build server 700, that is ultimately uploaded to the UI tier 504 though this is merely one example of a host of others including the use of hardware. The script essentially includes an image of the UI the user is to use and built by the build server 700. While not shown, in some embodiments, the output of the controller 604 of FIG. 6 is combined with the output of the compiler 704 to create the UI image that is uploaded to the UI tier 504. An updated installation script is generated by the build server 700 of FIG. 7, when needed, for example, when additional clouds are added or clouds are removed or features are added and the like.

The controller 604, of FIG. 6, is analogous to the master controller 1018 of FIG. 8. Alternatively, it may be a part of a slave cloud, such as the controllers 1020 and 1022 or it may be a part of all the controllers of all of the clouds 1002-1006.

The build server 700 may be externally located relative to the clouds and its output provided to a user for upload onto the UI tier 504, which would reside in the cloud, i.e. the servers 1012, 1014, and/or 1016.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A multi-cloud fabric system comprising:
a compiler responsive to a data model and operable to automatically generate artifacts for use by a plurality of plugins, the artifacts being distinct for each of the plugins, the artifacts used to create an image of a user interface (UI); and
a UI tier being responsive to the image of the UI to create a user UI,
wherein the user UI is generated automatically and the multi-cloud fabric system is data-driven to support multiple users.

2. The multi-cloud fabric system, as recited in claim 1, wherein the compiler is operable to utilize the data model to automatically create artifacts for creation and publishing of the user UI.

3. The multi-cloud fabric system, as recited in claim 2, wherein the compiler resides in a build server, the build server being located externally to one or more clouds, the one or more clouds including the controller.

4. The multi-cloud fabric system, as recited in claim 3, wherein the compiler is configured to cause centralized monitoring and dynamic orchestration of applications with network services across multiple clouds.

5. The multi-cloud fabric system, as recited in claim 1, further including a build server operable to combine an output of the controller with the plugins to generate the image of the UI.
